(19) United States
(12) Patent Application Publication
(10) Pub. No.: US 2002/0135943 A1
(43) Pub. Date: Sep. 26, 2002

(54) Noiseless magnetic head apparatus and flopply disk drive using the same

(75) Inventors: Hiroshi Nishizawa, Yokohama (JP); Katsuaki Kanaya, Yokohama (JP); Masaki Sato, Yokohama (JP)

Correspondence Address: CONNOLLY BOVE LODGE & HUTZ LLP, SUITE 800, 1990 M STREET NW, WASHINGTON, DC, 20036-3425, US

(73) Assignee: MATSUSHITA ELECTRIC INDUSTRIAL CO., LTD., Osaka (JP)

(21) Appl. No.: 10/096,626

(22) Filed: Mar. 14, 2002

(30) Foreign Application Priority Data
Mar. 22, 2001 (JP) 2001-81794
Mar. 22, 2001 (JP) 2001-83615
Mar. 22, 2001 (JP) 2001-83619

(51) Int. Cl. G11B 5/48

(52) U.S. Cl. 360/246.1

(57) ABSTRACT

A magnetic read/write head apparatus which may be used in a floppy disk drive for personal computers. The head apparatus is designed to have an improved structure working to eliminate noise components contained in output signals. The structure has magnetic head cores and dummy magnetic head cores. The dummy magnetic head cores work to produce outputs 180° out of phase with outputs of the magnetic head cores, thereby canceling noises contained in the outputs of the magnetic head cores.

### BACKGROUND OF THE INVENTION

1. Technical Field of the Invention

The present invention relates generally to a magnetic read/write head apparatus, and a floppy disk drive using the same which are useful particularly in personal computers, and more particularly to an improved structure of such a magnetic read/write head apparatus designed to eliminate noise components contained in an output signal, and a floppy disk drive using the same.

2. Background Art

Japanese Patent First Publication No. 7-254107 and Japanese Utility Model First Publication No. 3-124309 disclose a conventional magnetic read/write head useful in personal computers which is surrounded by a magnetic shield to protect the head from external magnetic noises. In recent years, the magnetic heads and floppy disk drives are required to have a reduced size and improve the portability thereof, thereby resulting in an increasing need for the improvement of impact resistance thereof.

FIGS. 12 and 13 show a conventional head carriage assembly as disclosed in the above publication No. 3-124309.

The head carriage assembly has, as clearly shown in FIG. 113, an upper magnetic head 40b and a lower magnetic head 40a opposed to each other to form a nip in which a magnetic storage medium such as a floppy disk is held. The upper and lower magnetic heads 40b and 40a have the same structure illustrated in FIG. 14 (only the lower magnetic head 40a is shown for the brevity of illustration). The lower magnetic head 40a includes a mount plate 2a and a ferrite-made shield ring 41a. The shield ring 41a is installed on the mount plate 2a and surrounds the magnetic head 40a for eliminating external noises through hysteresis loss and eddy-current loss. Similarly, the upper magnetic head 40b includes, as shown in FIG. 13, a mount plate 2b and a ferrite-made shield ring 41b.

The above structure, however, has several problems in that the shield rings 41a and 41b are, as described above, made of ferrite that is a hard fragile material and thus very sensitive to external physical impacts, that the shielding capability is insufficient to remove external noises completely, and that a variation in positional relation between the shield rings 41a and 41b leads to great variations in shielding capability thereof, thus requiring a large amount of time for positioning the shield rings 41a and 41b properly.

### SUMMARY OF THE INVENTION

It is therefore a principal object of the invention to avoid the disadvantages of the prior art.

It is another object of the invention to provide an easy-to-assemble structure of a magnetic head apparatus which is capable of eliminating unwanted noise components contained in an output signal, and a floppy disk drive using the same.

According to one aspect of the invention, there is provided a magnetic head apparatus which may be used a portable computer to read and/or write information data on and/or from a storage medium such as a floppy disk. The magnetic head apparatus comprises: (a) a first magnetic head having a first magnetic head core and a first coil wound around the magnetic head core; (b) a second magnetic head having a second magnetic head core and a second coil wound around the second magnetic head core, the second magnetic head being opposed to the first magnetic head so as to form a nip in which a magnetic storage medium is held for reading and writing data on and from the magnetic storage medium; (c) a first dummy magnetic head core around which a first dummy coil is wound to form substantially the same magnetic circuit as that of the first magnetic head, the first dummy magnetic head core being located adjacent the first magnetic head core out of alignment with the second magnetic head core through the magnetic storage medium; and (d) a second magnetic head core around which a second dummy coil is wound to form substantially the same magnetic circuit as that of the second magnetic head. The second dummy magnetic head core is located adjacent the second magnetic head core out of alignment with the first magnetic head core through the magnetic storage medium. The first dummy coil is connected electrically with the first coil of the first magnetic head so that an output of the first dummy coil is added to that of the first coil of the first magnetic head in opposite phase to each other. Similarly, the second dummy coil is connected electrically with the second coil of the second magnetic head so that an output of the second dummy coil is added to that of the second coil of the second magnetic head in opposite phase to each other. This cancels noise components contained in the outputs of the first and second magnetic head cores. The misalignment of the first and second dummy magnetic head cores with the first and second magnetic head cores serves to avoid the degradation of magnetic characteristics, for example, the overwriting capability due to an increase in inductance.

In the preferred mode of the invention, sliders are further provided each of which surrounds one of the first and second magnetic head cores. Each of the sliders is made of a non-magnetic insulating material.

The first and second magnetic head cores may be made of a polycrystalline ferrite such as an Mn—Zn ferrite.

Each of the first and second dummy head cores is covered with a corresponding one of the sliders so as not to be opposed outside a surface of the slider.

The first and second coils and the first and second dummy coils have middle taps connected to each other.

Each of the first and second coils and the first and second dummy coils is made up of windings connected in series.

Each of the first and second dummy magnetic head cores has a magnetic gap located at a distance from the surface of the one of the sliders which is greater than a wavelength of a signal recorded on the magnetic storage medium.

The nip formed between the first magnetic head and the second magnetic head holds opposed surfaces forming a thickness of the magnetic storage medium. The first dummy magnetic head core and the second dummy magnetic core are arranged out of alignment with the second magnetic head core and the first magnetic head core in a direction perpendicular to the opposed surfaces of the magnetic storage medium, respectively.

According to the second aspect of the invention, there is provided a floppy disk drive which has a noiseless head structure comprising: (a) a drive mechanism working to rotate a floppy disk for reading and writing data from and on a floppy disk; and (b) a magnetic head carriage assembly. The magnetic head carriage assembly is designed to minimize noise components contained in outputs reproduced from a floppy disk. The magnetic head carriage assembly includes: (a) a first magnetic head having a first magnetic head core and a first coil wound around the magnetic head core; (b) a second magnetic head having a second magnetic head core and a second coil wound around the second magnetic head core, the second magnetic head being opposed to the first magnetic head so as to form a nip in which a magnetic storage medium is held for reading and writing data on and from the magnetic storage medium; (c) a first dummy magnetic head core around which a first dummy coil is wound to form substantially the same magnetic circuit as that of the first magnetic head, the first dummy magnetic head core being located adjacent the first magnetic head core out of alignment with the second magnetic head core through the magnetic storage medium, the first dummy coil being connected electrically with the first coil of the first magnetic head so that an output of the first dummy coil is added to that of the first coil of the first magnetic head in opposite phase to each other; and (d) a second magnetic head core around which a second dummy coil is wound to form substantially the same magnetic circuit as that of the second magnetic head, the second dummy magnetic head core being located adjacent the second magnetic head core out of alignment with the first magnetic head core through the magnetic storage medium, the second dummy coil being connected electrically with the second coil of the second magnetic head so that an output of the second dummy coil is added to that of the second coil of the second magnetic head in opposite phase to each other.

In the preferred mode of the invention, sliders are further provided each of which surrounds one of the first and second magnetic head cores. Each of the sliders being made of a non-magnetic insulating material.

Each of the first and second magnetic head cores is made of a polycrystalline ferrite such as an Mn—Zn ferrite.

Each of the first and second dummy head cores is covered with a corresponding one of the sliders so as not to be opposed outside a surface of the slider.

Each of the first and second dummy magnetic head cores has a magnetic gap located at a distance from the surface of the one of the sliders which is greater than a wavelength of a signal recorded on the floppy disk.

The first and second coils and the first and second dummy coils have middle taps connected to each other.

Each of the first and second coils and the first and second dummy coils is made up of windings connected in series.

According to the third aspect of the invention, there is provided a magnetic head apparatus which is designed to minimize noise components contained in outputs reproduced from a storage medium such as a floppy disk. The magnetic head apparatus comprises: (a) a first magnetic head having a first magnetic head core and a first coil wound around the magnetic head core; (b) a second magnetic head having a second magnetic head core and a second coil wound around the second magnetic head, the second magnetic head being opposed to the first magnetic head so as to form a nip in which a thickness of a magnetic storage medium are held for reading and writing data on and from the magnetic storage medium; (c) a first dummy magnetic head core around which a first dummy coil is wound to form substantially the same magnetic circuit as that of the first magnetic head, the first dummy magnetic head core being located at a distance of more than or equal to the thickness of the magnetic storage medium from the first magnetic head core in a direction away from the magnetic storage medium and in a thicknesswise direction of the magnetic storage medium; and (d) a second dummy magnetic head core around which a second dummy coil is wound to form substantially the same magnetic circuit as that of the second magnetic head, the second dummy magnetic head core being located at a distance of more than or equal to the thickness of the magnetic storage medium from the second magnetic head core in a direction away from the magnetic storage medium and in a thicknesswise direction of the magnetic storage medium. The first dummy coil is connected electrically with the first coil of the first magnetic head so that an output of the first dummy coil is added to that of the first coil of the first magnetic head in opposite phase to each other. Similarly, the second dummy coil is connected electrically with the second coil of the second magnetic head so that an output of the second dummy coil is added to that of the second coil of the second magnetic head in opposite phase to each other. Specifically, noise components contained in outputs of the first and second dummy magnetic head cores are added to those contained in outputs of the first and second magnetic head cores in an opposite phase relation, thereby canceling the noise components.

In the preferred mode of the invention, sliders are further provided each of which surrounds one of the first and second magnetic head cores. Each of the sliders is made of a non-magnetic insulating material.

Each of the first and second magnetic head cores is made of a polycrystalline ferrite such as an Mn—Zn ferrite.

Each of the first and second dummy head cores is covered with a corresponding one of the sliders so as not to be opposed outside a surface of the slider.

The first and second coils and the first and second dummy coils have middle taps connected to each other.

Each of the first and second coils and the first and second dummy coils is made up of windings connected in series.

Each of the first and second dummy magnetic head cores has a magnetic gap located at a distance from the surface of the one of the sliders which is greater than a wavelength of a signal recorded on the floppy disk.

According to the fourth aspect of the invention, there is provided a floppy disk drive which has a noiseless head structure comprising: (a) a drive mechanism working to rotate a floppy disk for reading and writing data from and on a floppy disk; and (b) a magnetic head carriage assembly. The magnetic head carriage assembly is designed to minimize noise components contained in outputs reproduced from a floppy disk. The magnetic head carriage assembly includes: (a) a first magnetic head having a first magnetic head core and a first coil wound around the magnetic head core; (b) a second magnetic head having a second magnetic head core and a second coil wound around the second magnetic head, the second magnetic head being opposed to the first magnetic head so as to form a nip in which a thickness of a magnetic storage medium is held for reading and writing data on and from the magnetic storage medium; (c) a first dummy magnetic head core around which a first dummy coil is wound to form substantially the same magnetic circuit as that of the first magnetic head, the first dummy magnetic head core being located at a distance of more than or equal to the thickness of the magnetic storage medium from the first magnetic head core in a direction away from the magnetic storage medium and in a thicknesswise direction of the magnetic storage medium, the first dummy coil being connected electrically with the first coil of the first magnetic head so that an output of the first dummy coil is added to that of the first coil of the first magnetic head in opposite phase to each other; and (d) a second dummy magnetic head core around which a second dummy coil is wound to form substantially the same magnetic circuit as that of the second magnetic head, the second dummy magnetic head core being located at a distance of more than or equal to the thickness of the magnetic storage medium from the second magnetic head core in a direction away from the magnetic storage medium and in a thicknesswise direction of the magnetic storage medium, the second dummy coil being connected electrically with the second coil of the second magnetic head so that an output of the second dummy coil is added to that of the second coil of the second magnetic head in opposite phase to each other.

In the preferred mode of the invention, sliders are further provided each of which surrounds one of the first and second magnetic head cores. Each of the sliders is made of a non-magnetic insulating material.

Each of the first and second magnetic head cores is made of a polycrystalline ferrite such as Mn—Zn ferrite.

Each of the first and second dummy head cores is covered with a corresponding one of the sliders so as not to be opposed outside a surface of the slider.

Each of the first and second dummy magnetic head core has a magnetic gap located at a distance from the surface of the one of the sliders which is greater than a wavelength of a signal recorded on the floppy disk.

The first and second coils and the first and second dummy coils have middle taps connected to each other.

Each of the first and second coils and the first and second dummy coils is made up of windings connected in series.

According to the fifth aspect of the invention, there is provided a magnetic head apparatus which is designed to minimize noise components contained in outputs reproduced from a storage medium such as a floppy disk. The magnetic head apparatus comprises: (a) a first magnetic head having a first magnetic head core and a first coil wound around the magnetic head core; (b) a second magnetic head having a second magnetic head core and a second coil wound around the second magnetic head core, the second magnetic head being opposed to the first magnetic head so as to form a nip in which a magnetic storage medium is held for reading and writing data on and from the magnetic storage medium; (c) a first dummy magnetic head core around which a first dummy coil is wound to form substantially the same magnetic circuit as that of the first magnetic head, the first dummy magnetic head core having no magnetic gap used to read and write data on and from the magnetic storage medium and being located adjacent the first magnetic head core out of alignment with the second magnetic head core through the magnetic storage medium; and (d) a second magnetic head core around which a second dummy coil is wound to form substantially the same magnetic circuit as that of the second magnetic head, the second dummy magnetic head core having no magnetic gap used to read and write data on and from the magnetic storage medium and being located adjacent the second magnetic head core out of alignment with the first magnetic head core through the magnetic storage medium. The first dummy coil is connected electrically with the first coil of the first magnetic head so that an output of the first dummy coil is added to that of the first coil of the first magnetic head in opposite phase to each other. The second dummy coil is connected electrically with the second coil of the second magnetic head so that an output of the second dummy coil is added to that of the second coil of the second magnetic head in opposite phase to each other. Specifically, noise components contained in outputs of the first and second dummy magnetic head cores are added to those contained in outputs of the first and second magnetic head cores in an opposite phase relation, thereby canceling the noise components.

In the preferred mode of the invention, sliders are further provided each of which surrounds one of the first and second magnetic head cores. Each of the sliders is made of a non-magnetic insulating material.

Each of the first and second magnetic head cores is made of a polycrystalline ferrite such as an Mn—Zn ferrite.

An outer surface of each of the first and second dummy head cores lies flush with an outer surface of a corresponding one of the sliders and has no magnetic gap.

The first and second coils and the first and second dummy coils each have a middle tap.

Each of the first and second coils and the first and second dummy coils is made up of windings connected in series.

The nip formed between the first magnetic head and the second magnetic head holds a thickness of the magnetic storage medium. The first dummy magnetic head core and the second dummy magnetic core are arranged out of alignment with the second magnetic head core and the first magnetic head core in a thicknesswise direction of the magnetic storage medium, respectively.

According to the sixth aspect of the invention, there is provided a floppy disk drive which has a noiseless head structure comprising: (a) a drive mechanism working to rotate a floppy disk for reading and writing data from and on a floppy disk; and (b) a magnetic head carriage assembly. The magnetic head carriage assembly is designed to minimize noise components contained in outputs reproduced from a floppy disk. The magnetic head carriage assembly includes: (a) a first magnetic head having a first magnetic head core and a first coil wound around the magnetic head core; (b) a second magnetic head having a second magnetic head core and a second coil wound around the second magnetic head core, the second magnetic head being opposed to the first magnetic head so as to form a nip in which a magnetic storage medium is held for reading and writing data on and from the magnetic storage medium; (c) a first dummy magnetic head core around which a first dummy coil is wound to form substantially the same magnetic circuit as that of the first magnetic head, the first dummy magnetic head core having no magnetic gap used to read and write data on and from the magnetic storage medium and being located adjacent the first magnetic head core out of alignment with the second magnetic head core through the magnetic storage medium, the first dummy coil being connected electrically with the first coil of the first magnetic head so that an output of the first dummy coil is added to that of the first coil of the first magnetic head in opposite phase to each other; and (d) a second magnetic head core around which a second dummy coil is wound to form substantially the same magnetic circuit as that of the second magnetic head, the second dummy magnetic head core having no magnetic gap used to read and write data on and from the magnetic storage medium and being located adjacent the second magnetic head core out of alignment with the first magnetic head core through the magnetic storage medium, the second dummy coil being connected electrically with the second coil of the second magnetic head so that an output of the second dummy coil is added to that of the second coil of the second magnetic head in opposite phase to each other.

In the preferred mode of the invention, sliders are further provided each of which surrounds one of the first and second magnetic head cores. Each of the sliders is made of a non-magnetic insulating material.

Each of the first and second magnetic head cores is made of a polycrystalline ferrite such as an Mn—Zn ferrite.

An outer surface of each of the first and second dummy head cores lies flush with an outer surface of a corresponding one of the sliders.

The first and second coils and the first and second dummy coils have middle taps connected to each other.

Each of the first and second coils and the first and second dummy coils is made up of windings connected in series.

The nip formed between the first magnetic head and the second magnetic head holds a thickness of the magnetic storage medium. The first dummy magnetic head core and the second dummy magnetic core are arranged out of alignment with the second magnetic head core and the first magnetic head core in a thicknesswise direction of the magnetic storage medium, respectively.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1(a) is a top view which shows a head carriage assembly in which magnetic heads according to the first embodiment of the invention are mounted.

FIG. 1(b) is a side view of FIG. 1(a);

FIG. 2 is a perspective view which shows a structure of a lower magnetic head;

FIG. 3 is a vertical sectional view which shows upper and lower magnetic heads according to the first embodiment of the invention;

FIG. 4 is a partially perspective view which shows a portion surrounded by a broken circle A in FIG. 2;

FIG. 5 is a vertical sectional view which shows a magnetic head core of FIG. 4;

FIG. 6 is a circuit diagram of a lower magnetic head in the first embodiment of the invention;

FIG. 7 shows waveforms of reproduced signals outputted from the lower magnetic head of FIG. 6;

FIG. 8 is an exploded perspective view which shows a floppy disk drive in which the head carriage assembly of FIGS. 1(a) and 1(b) is mounted;

FIG. 9 is a vertical sectional view which shows upper and lower magnetic heads according to the second embodiment of the invention;

FIG. 10 is a vertical sectional view which shows upper and lower magnetic heads according to the third embodiment of the invention;

FIG. 11 is a circuit diagram of a lower magnetic head in the third embodiment of the invention;

FIG. 12 is a top view which shows a conventional head carriage assembly;

FIG. 13 is a side view of FIG. 12; and

FIG. 14 is a perspective view which shows a structure of a lower magnetic head as illustrated in FIG. 13.

### DESCRIPTION OF THE PREFERRED EMBODIMENTS

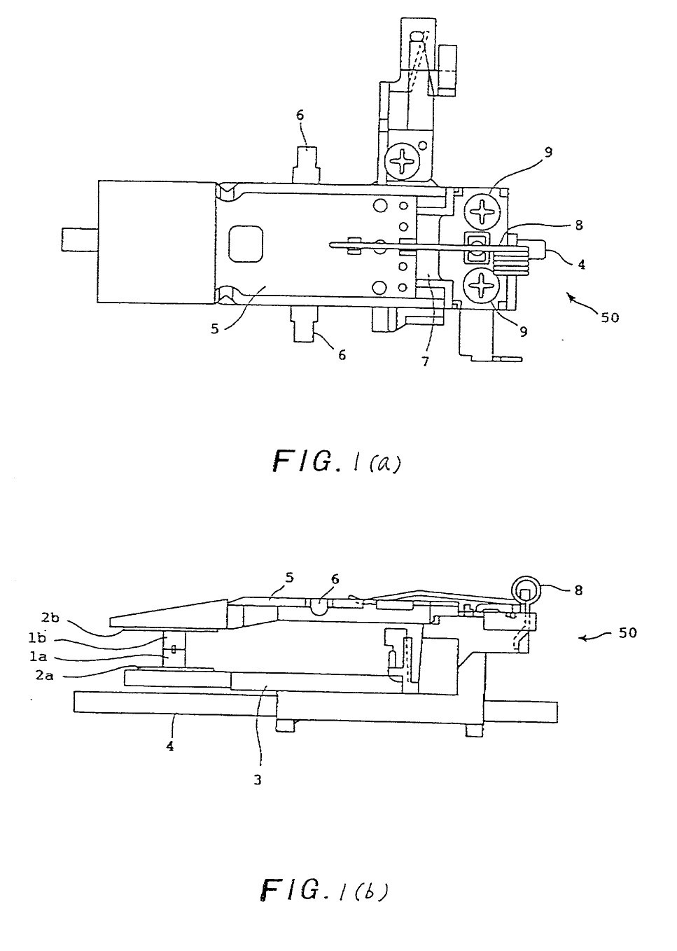

Referring to the drawings, wherein like reference numbers refer to like parts in several views, particularly to FIGS. 1(a) and 1(b), there is shown a head carriage assembly 50 according to the first embodiment of the invention.

The head carriage assembly 50 includes generally an upper magnetic head 1b and a lower magnetic head 1a opposed to each other through a magnetic storage medium (not shown). In the following discussion, it is assumed that the magnetic storage medium is a 3.5-inch flexible storage medium (generally called a floppy disk) as specified in JIS (Japanese Industrial Standard) X 6223.

The upper magnetic head 1b is secured on an arm 5 through a mount plate 2b. The lower magnetic head 1a is secured on a carriage 3 through a mount plate 2a. The mount plate 2b is made of a stainless steel (e.g., SUS304) having a thickness of 0.05 mm and has the upper magnetic head 1b glued in place. The mount plate 2a is made of a stainless steel (e.g., SUS304) having a thickness of 0.2 mm and has the lower magnetic head 1a glued in place. The mount plate 2b is configured in the form of a gimbal spring to give free movement in two directions to the upper magnetic head 1b for ensuring the stability of contact with the floppy disk.

The carriage 3 has formed therein a hole through which a guide rod 4 is inserted for supporting the carriage 3. The guide rod 4 is moved back and forth by a drive mechanism (not shown) to guide the carriage 3 in a radial direction of the floppy disk, thereby moving the magnetic heads 1a and 1b in a tracking direction of the floppy disk.

A thin leaf spring 7 called a roll pivot is, as clearly shown in FIG. 1(a), mounted adjacent the base of the arm 5 on the carriage 3 using screws 9. The roll pivot 7 is made of a stainless steel plate (e.g., SUS304 CSP) having a thickness of 0.05 mm. The arm 5 has formed thereon protrusions 6 for allowing the arm 6 to rotate as a whole with aid of movement of a holder, as discussed later in detail, and the roll pivot 7. A load spring 8 is installed on the carriage 3 to exert a given load or pressure on the upper magnetic head 1b to bring the upper magnetic head 1b into constant engagement with the lower magnetic head 1a to form a nip in which the floppy disk is retained for writing or reading data on or from the floppy disk.

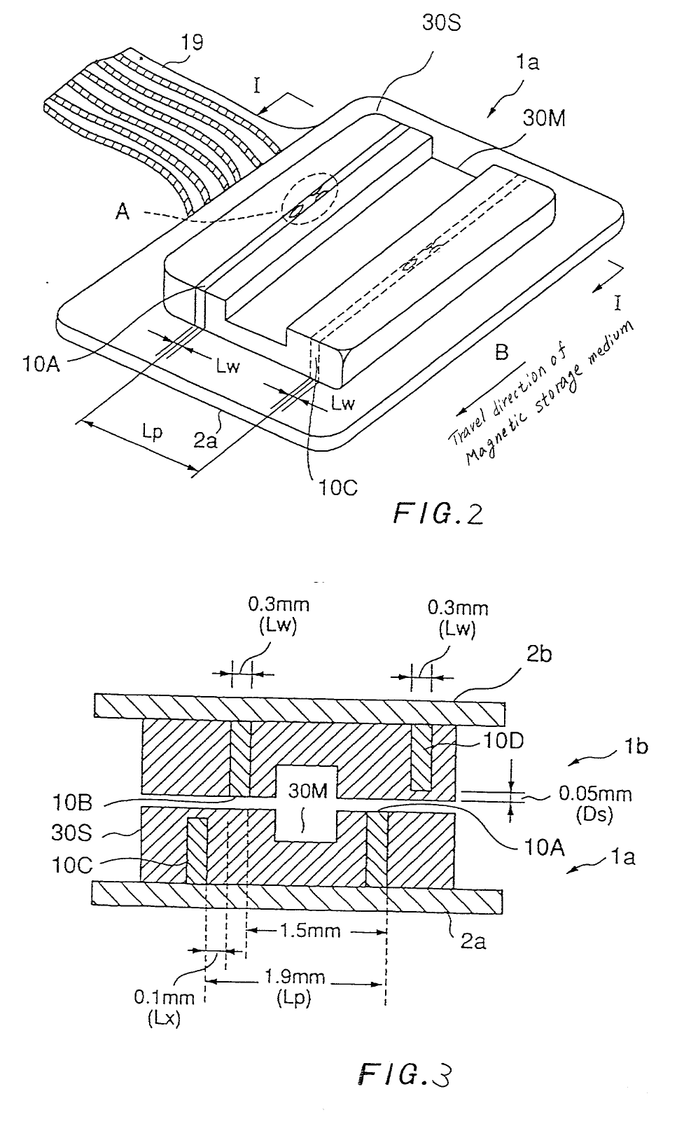

The lower magnetic head 1a includes, as shown in FIGS. 2 and 3, a magnetic head core 10A made of a soft magnetic material and a dummy magnetic head core 10C which have equivalent magnetic circuits.

The upper magnetic head 1b has, as shown in FIG. 3, a magnetic head core 10B and a dummy magnetic head core 10D arranged out of alignment with the dummy magnetic head core 10C and the magnetic head core 10A of the lower magnetic head 1a, respectively, in a thicknesswise direction of the floppy disk. Other arrangements are identical with those of the lower magnetic head 1b, as will be discussed below, and explanation thereof in detail will be omitted here.

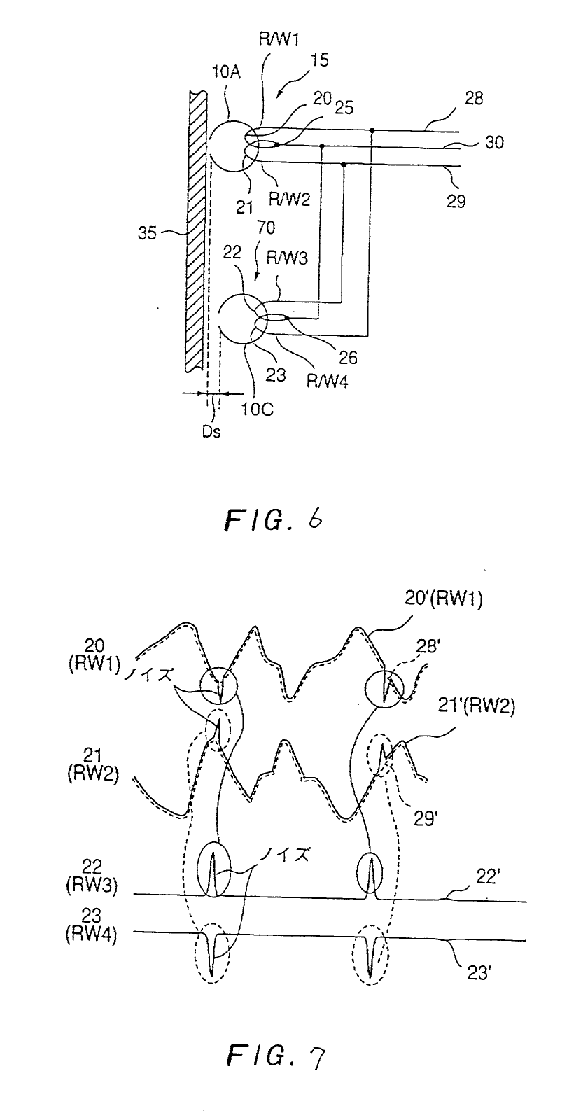

The magnetic head core 10A and the dummy magnetic head core 10C of the lower magnetic head 1a are fitted in a slider 30S. The magnetic head core 10A and the dummy magnetic head core 10C have, as clearly shown in FIG. 6, coils 15 and 70 wound therearound. A flexible cable 19, as shown in FIG. 2, is joined to the magnetic head 1a in electric connection with terminals of the coils 15 and 70 for establishing transmission of electric signals between them and an associated circuit (not shown).

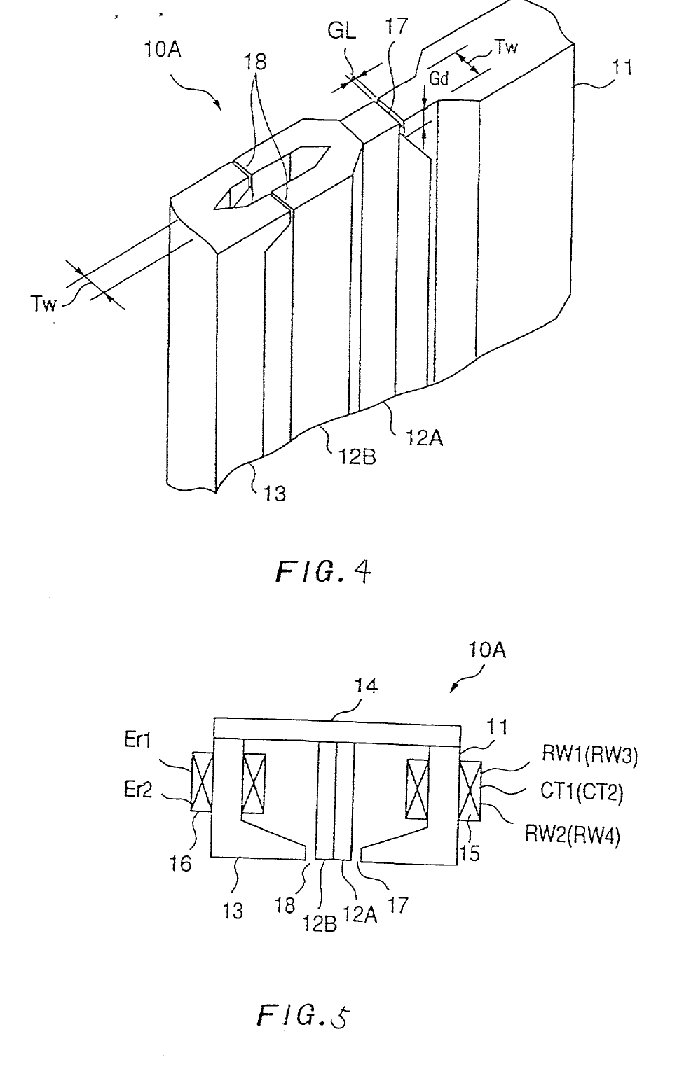

Each of the magnetic head cores 10A and 10C is made of a polycrystalline substance such as a Mn—Zn ferrite material whose grain size is about 5 μm and has, as clearly shown in FIG. 4, a track width Tw of 120 μm, a gap length GL of 0.9 μm, and a gap depth Gd of 35 μm. The slider 30S is made of a ceramic material whose main component is calcium titanate and also generally called a ceramic slider. The calcium titanate is close in coefficient of thermal expansion to the Mn—Zn ferrite material of the magnetic head cores 10A and 10C, thus avoiding unwanted stress on the magnetic head cores 10A and 10C arising from elevation in temperature thereof during a machining process, which decreases the deterioration of magnetic characteristics thereof.

The slider 30S is shaped to ensure the stability of contact with the floppy disk and minimize the wear of the floppy disk. The slider 30S, as clearly shown in FIG. 2, has a central groove 30M extending in parallel to the direction B in which the floppy disk travels. The slider 30S has a storage medium contact surface which has given width, length, roughness, and crown and is chamfered properly.

An outer surface of the dummy magnetic head core 10C is located inwardly of an outer surface of the slider 30C by about 0.05 mm, so that a magnetic gap thereof is not exposed outside the surface of the slider 30C. Specifically, the magnetic gap is, as clearly shown in FIG. 3, at a distance Ds of greater than or equal to a recording wavelength from the surface of the slider 30C in a thicknesswise direction of the floppy disk. In positional relations of the upper and lower magnetic heads 1b and 1a to the floppy disk in the tracking direction perpendicular to the direction B (i.e., the radius direction of the floppy disk), the magnetic head core 10A of the lower magnetic head 1a is located inwardly by eight tracks of the floppy disk (i.e., 1.5 mm) from the magnetic head core 10B of the upper magnetic head 1b. The width Lw, as shown in FIG. 2, of each of the magnetic head core 10A and the dummy magnetic head core 10C is 0.3 mm. The internals Lp between the magnetic head core 10A and the dummy magnetic head core 10C and between the magnetic head core 10B and the dummy magnetic head core 10D are 1.9 mm. With this arrangement, the magnetic head core 10A and the dummy magnetic head core 10C of the lower magnetic head 1a are arranged, as can be seen from FIG. 3, out of alignment with the dummy magnetic head core 10D and the magnetic head core 10B of the upper magnetic head 1b, respectively.

A minimum interval Lx between the magnetic head core 10B of the upper magnetic head 1b and the dummy magnetic head core 10C of the lower magnetic head 1a in a lengthwise direction of the magnetic heads 1a and 1b (i.e., the lateral direction, as viewed in the drawing) is 0.1 mm (=1.9−1.5−0.3 mm) which is greater than the thickness of the floppy disk (80 μm). This avoids the degradation of magnetic characteristics, for example, the overwriting capability due to an increase in inductance. This is thought of as arising from the fact that one of the head cores 10B and 10C behave as a back yoke to the R/W gap of the other of the head cores 10B and 10C, resulting in an increase in degree of magnetic coupling of the magnetic head cores 10B and 10C, which increases the inductance to weaken the rising of a writing current. In general, the proper overwriting capability is considered to be less than −24 dB.

We performed tests in two cases where the intervals Lp between the magnetic head core 10A and the dummy magnetic head core 10C and between the magnetic head core 10B and the dummy magnetic head core 10D are 1.5 mm so that the magnetic head core 10A and the dummy magnetic head core 10C may be oriented in alignment with the dummy magnetic head core 10D and the magnetic head core 10B, respectively, in a thicknesswise direction of the slider 30S and where the intervals Lp between the magnetic head core 10A and the dummy magnetic head core 10C and between the magnetic head core 10B and the dummy magnetic head core 10D are 1.9 mm so that the magnetic head core 10A and the dummy magnetic head core 10C may be oriented out of alignment with the dummy magnetic head core 10D and the magnetic head core 10B, respectively. The former test results showed that an output signal read out of the magnetic storage medium has a level of about −20 dB, while the latter test results showed that an output signal read out of the magnetic storage medium has a desired level of about −28 dB.

The same arrangements, as described above, hold true of the magnetic head core 10A of the lower magnetic head 1a and the dummy magnetic head core 10D of the upper magnetic head 1b.

FIG. 4 is an enlarged perspective view which shows a gap portion A, as illustrated in FIG. 2. The gap portion A consists of a C-shaped R/W (read/write) core 11, I-shaped cores 12A and 12B (also called center cores), and a C-shaped Er (Erase) core 13. The C-shaped core 11 and the I-shaped core 12A define an R/W gap therebetween. The I-shaped core 12B and the C-shaped core 13 define an Er (Erase) gap 18 therebetween. The cores 11, 12A, 12B, and 13, as clearly shown in FIG. 5, have ends opposite the ends, as illustrated in FIG. 4, which are connected together by a back bar 14 to close the magnetic circuit. The R/W gap 17 is defined by the track width Tw, the gap length GL, and the gap depth Gd, as described above. The Er gap 18 has track widths Tw of 70 μm on both sides 120 μm apart, a gap length GL of 2.5 μm, and a gap depth Gd of 50 μm. These dimensions may be selected in every storage medium.

FIG. 5 shows a positional relation among the cores 11 and 13, a R/W coil 15, and an Er coil 16. The R/W coil 15 is made of copper wire having a diameter of 0.03 mm wound round the C-shaped R/W core 11 with two sets of 120 turns which are in opposite winding directions and connected in series through a center tap CT. Leading and trailing ends of the R W coil 15 are indicated in FIG. 5 by R/W1 and R/W2, respectively. The Er coil 16 is made of 120 turns of copper wire having a diameter of 0.05 mm wound around the C-shaped Er core 13 and has leading and trailing ends Er1 and Er2.

The dummy magnetic head core 10C has the same structure as illustrated in FIGS. 4 and 5. Specifically, the dummy magnetic head core 10C has, as shown in FIG. 6, a R/W coil 70 identical in structure with the R/W coil 15. The height of the dummy magnetic head core 10C (corresponding to the vertical distance between upper and lower ends as illustrated in FIG. 5) is, however, lower than the magnetic head core 10A, so that the dummy magnetic head core 10C, as clearly shown in FIG. 3, is not exposed outside the surface of the slider 30S. The dummy magnetic head core 10C does not have an Er coil such as the Er coil 16.

FIG. 6 is a circuit diagram which shows electrical connections of the R/W coil 15 of the magnetic head core 10A and the R/W coil 70 of the magnetic head core 10C. FIG. 6 illustrates the lower magnetic head 1a facing the surface of a 3.5-inch floppy disk 35 and omits the upper magnetic head 1b for the brevity of illustration. The R/W coil 15 is, as described above, made of two windings: a first winding 20 formed between the leading end R/W1 and the center tap 25 and a second winding 21 formed between the center tap 25 and the trailing end R/W2. The first winding 20 is made of wire wound in a clockwise direction, while the second winding 21 is made of wire wound in a counterclockwise direction.

The R/W coil 70 of the dummy magnetic head core 10C works as a dummy coil and is, like the R/W coil 15, made of a first winding 22 formed between the leading end R/W3 and the center tap 26 and a second winding 23 formed between the center tap 26 and the trailing end R/W4.

The R/W coil 15 is connected electrically with the R/W coil 70 in the manner as illustrated in FIG. 6. Specifically, the center taps 25 and 26 are joined together. The leading end R/W1 of the R/W coil 15 is joined to the trailing end R/W4 of the R/W coil 70. The trailing end R/W2 of the R/W coil 15 is joined to the leading end R/W3 of the R/W coil 70. This joining is an opposite phase connection which works to cancels electromotive forces each other which are produced in the R/W coils 15 and 70 by external noises.

The windings 20, 21, 22, and 23 of the R/W coils 15 and 70 are connected at terminals or ends R/W1, R/W2, R/W3, and R/W4 to a control circuit (not shown) installed in a floppy disk drive through conductive lines 28, 29, and 30 of the flexible cable 19.

FIG. 7 shows waveforms of read signals developed in the windings 20, 21, 22, and 23 of the R/W coils 15 and 70 in a case where the center taps 25 and 26 are connected to ground. Solid lines 20′ and 21′ indicate signals which carry information data read out of the floppy disk 35 and appear at the terminals R/W1 and R/W2 of the magnetic head core 10A, respectively. Solid lines 22′ and 23′ indicate signals which are developed at the terminals R/W3 and R/W4 of the R/W coil 70 of the dummy magnetic head core 10C, respectively. The reason that the signals 22′ and 23′ developed at the dummy magnetic head core 10C do not contain components indicating the information data read out of the floppy disk 35 is because the dummy magnetic head core 10C is embedded in the slider 30S at the distance Ds greater than the wavelength of a recorded signal from the surface of the slider 30S, thereby resulting in a spacing loss.

Two sharp portion or bursts of each of the signals 20′, 21′, 22′, and 23′ are noise components produced by electromotive forces developed by external electric noises in the windings 20, 21, 22, and 23 of the magnetic head cores 10A and 10C. The windings 20, 21, 22, and 23 are, as described above, connected in opposite phase to each other, thus causing the bursts of the output signals 22′ and 23′ to cancel those of the output signals 20′ and 21′, respectively. This causes output signals transmitted through the conductive lines 28, 29, and 30 of the flexible cable 19 to have waveforms, as indicated by broken lines 28′ and 29′, with no bursts.

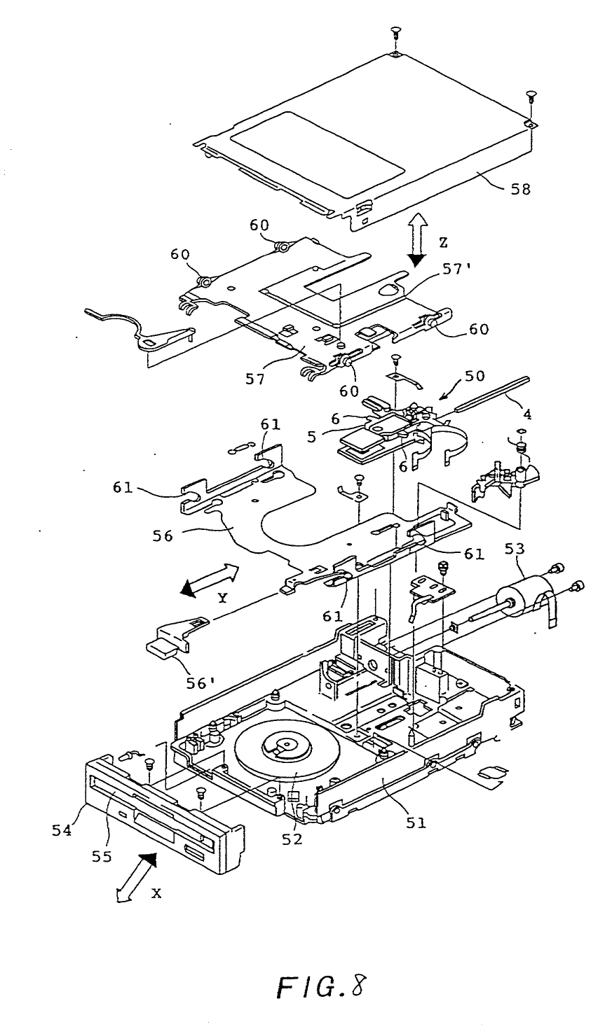

FIG. 8 is an exploded perspective view which shows a floppy disk drive in which the head carriage assembly 50 as described above. On an aluminum die cast chassis 51, a spindle motor 52, a panel 54, and a load/unload mechanism are installed. The spindle motor 52 works to rotate a floppy disk. The panel 54 has a slot 55 through which the floppy disk is loaded into or unloaded from the floppy disk drive through the load/unload mechanism. The loading of the floppy disk into the floppy disk drive is accomplished by inserting the floppy disk through the slot 55 in a direction, as indicated by a black triangle of an arrow X. Upon insertion of the floppy disk into the slot 55, an eject lever 56 is moved in a direction, as indicated by a black triangle of an arrow Y, to shift a holder 57 in a direction, as indicated by a black triangle of an arrow Z with aid of activities of slant cam grooves 61 formed in the eject lever 56 and pins 60 installed in the holder 57.

Conversely, the unloading of the floppy disk from the floppy disk drive is accomplished by pushing an eject button 56′. Upon pushing the eject button 56′, the eject lever 56 is moved in a direction, as indicated by a white triangle of the arrow Y, to shift the holder 57 in a direction, as indicated by a white triangle of the arrow Z, thereby ejecting the floppy disk from the slot 55. Specifically, when the holder 57 moves in the direction, as indicated by the white triangle of the arrow Z, it causes the whole of the arm 5 of the head carriage assembly 50 to is rotated about the roll pivot 7, as shown in FIG. 1(a), with aide of activities of the protrusions 6 formed on the arm 5 and a lift arm 57′ installed on the holder 57. When the floppy disk is loaded into the floppy disk drive, the arm 5 is moved downward to bring the magnetic heads 1a and 1b into contact with the floppy disk for recording or reproducing data on or from the floppy disk.

The head carriage assembly 50 is guided by the guide rod 4 in a tracking direction of the floppy disk accurately. The head carriage assembly 50 has installed therein the upper and lower magnetic heads 1b and 1a which form a nip in which the floppy disk is held. The head carriage assembly 50 is moved by a lead screw of a step motor 53 to a desired one of tracks of the floppy disk. A shield cover 58 works to protect internal structural components of the floppy disk drive physically and shield them from external electric noises. A printed circuit board is installed on the reverse surface of the chassis 51.

An operation of the floppy disk drive, as shown in FIG. 8, will be described below. In the following discussion, it is assumed that the floppy disk 35 has information data which is modified frequency modulated (MFM) and recorded on a plane area at a recording frequency of the order of 2 μm.

Each of the dummy magnetic head cores 10C and 10D of the upper and lower magnetic head 1b and 1a is, as described above in FIG. 3, embedded in a corresponding one of the sliders 30S at a distance Ds of approximately 0.05 mm from the surface the slider 30S, so that the magnetic gap is not exposed outside the slider 30S. The distance Ds is longer than or equal to the wavelength of a signal recorded on the floppy disk, thus resulting in spacing loss which causes output signals 22′ and 23′ of the dummy magnetic head core 10C, for example, not to contain components carrying information data read out of the floppy disk 35.

In general, it is known in the art that the spacing loss Ls that is a reduction in signal level or strength arising from the spacing d between a magnetic storage medium and a magnetic gap of a magnetic head is expressed by Ls =−20Log−2πd/λ≈54.6×d/λ. In this embodiment, d=0.05 mm, and λ=2 μm. Thus, Ls=1365 dB. It is found that a signal component reproduced from the floppy disk 35 will be decreased to a negligible level until it reaches each of the dummy magnetic head cores 10C and 10D. The output signals of each of the dummy magnetic head cores 10C and 10D, as can be seen in FIG. 7, do not essentially contain signal components carrying information data read out of the floppy disk 35.

The magnetic head core 10A and the dummy magnetic head core 10C are located adjacent each other, so that an external noise enters them almost simultaneously. The magnetic head core 10A and the dummy magnetic head core 10C have the magnetic circuits which are identical in structure with each other, but connected in the opposite phase relation without sacrificing the overwriting capability to form a differential circuit which works to produce differential output voltages 180° out of phase with each other, thereby eliminating a noise component contained in an output of the magnetic head core 10A. The same applies to the magnetic head core 10B and the dummy magnetic head core 10D of the upper magnetic head 1b.

We placed the floppy disk drive of this embodiment near a flyback transformer commonly used in a CRT generating a large amount of noise to check an error component contained in an output of each of the upper and lower magnetic heads 1b and 1a. We found that the output had no error component even when the floppy disk drive of this embodiment was placed at a distance from the flyback transformer which is half a distance at which a conventional floppy disk drive generated nonnegligible errors. The sliders 30S surround the magnetic cores 10A, 10B, 10C, and 10D and thus work to protect them against physical impacts and result in decreased wear thereof. We performed impact tests and found that a conventional magnetic head withstands an impact of approximately 250 G, while each of the magnetic heads 1a and 1b of this embodiment can withstand an impact of about 350 G. This results in greatly improved reliability of the floppy disk drive when used especially in portable computers.

An erasing operation of the floppy disk drive is not the major part of the invention, and explanation thereof in detail will be omitted here. The dummy magnetic head cores 10C and 10D are, as described above, arranged across the central grooves 30M formed in the sliders 30S, the invention is not limited to such an arrangement as long as the dummy magnetic head cores 10C and 10D are provided in close proximity to the magnetic head cores 10A and 10B and have the same magnetic circuits as those of the magnetic head cores 10A and 10B, respectively. The degree to which outputs of the dummy magnetic head cores 10C and 10D are added to outputs of the magnetic head cores 10A and 10B may be modified as needed.

The coils 15 and 70 are made of the windings 20 and 25 and the windings 22 and 23 which are connected in series, thus allowing the coils 15 and 70 to be produced at a lower cost with higher productivity than bifilars.

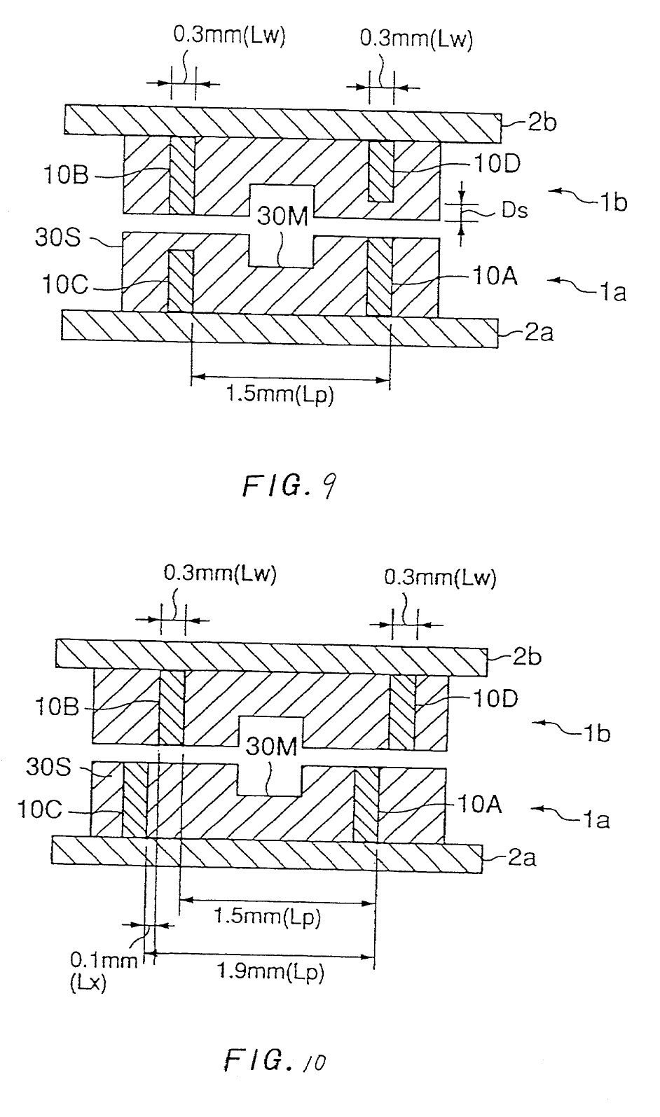

FIG. 9 shows the upper and lower magnetic heads 1b and 1a according to the second embodiment of the invention.

The dummy magnetic head core 10C is, like the first embodiment, embedded in the slider 30S at a depth of more than or equal to the wavelength of a signal recorded on a floppy disk. Specifically, the distance Ds between the outer surface of the slider 30S and an R/W magnetic gap of the dummy magnetic head core 10C is on the order of 0.2 mm. In positional relations of the upper and lower magnetic heads 1b and 1a to the floppy disk in the tracking direction perpendicular to the direction B (i.e., the radius direction of the floppy disk), the magnetic head core 10A of the lower magnetic head 1a is located inwardly by eight tracks of the floppy disk (i.e., 1.5 mm) from the magnetic head core 10B of the the upper magnetic head 1b. The width Lw, as shown in FIG. 2, of each of the magnetic head core 10A and the dummy magnetic head core 10C is 0.3 mm. The interval Lp between the magnetic head core 10A and the dummy magnetic head core 10C is, as clearly shown in FIG. 9, 1.5 mm. The magnetic head core 10A and the dummy magnetic head core 10C of the lower magnetic head 1a are arranged, as can be seen from FIG. 9, in alignment with the magnetic head core 10B and the dummy magnetic head core 10D of the upper magnetic head 1b, respectively, in a thicknesswise direction of the sliders 30S.

The dummy magnetic head cores 10C and 10D (i.e., the magnetic gaps thereof) are located at a distance of more than or equal to the thickness of the floppy disk from the magnetic head cores 10A and 10B in a direction away from the surface of the floppy disk. Specifically, the magnetic head core 10A and the dummy magnetic head core 10D are not in a positional relation which causes a magnetic leak, thus ensuring magnetic characteristics thereof properly. The same applies to the magnetic head core 10B and the dummy magnetic head core 10C.

The minimum intervals between the magnetic head core 10A of the lower magnetic head 1a and the dummy magnetic head core 10D of the upper magnetic head 1b and between the magnetic head core 10B of the upper magnetic head 1b and the dummy magnetic head core 10C of the lower magnetic head 1a are each greater than or equal to thickness of the floppy disk (80 μm). This avoids the degradation of magnetic characteristics, for example, the overwriting capability due to an increase in inductance. This is thought of as arising from the fact that one of the head cores 10A and 10D (or 10B and 10C) behave as a back yoke to the R/W gap of the other of the head cores 10A and 10D, resulting in an increase in degree of magnetic coupling of the magnetic head cores 10A and 10D, which increases the inductance to weaken the rising of a writing current. In general, the proper overwriting capability is, as already discussed, considered to be less than −24 dB.

We performed tests in two cases where the intervals Lp between the magnetic head core 10A and the dummy magnetic head core 10C and between the magnetic head core B and the dummy magnetic head core 10D are 1.5 mm, and the dummy magnetic head cores 10C and 10D are located 2 μm away from the magnetic head cores 10A and 10B in the direction away from the magnetic storage medium, respectively, and where the dummy magnetic head cores 10C and 10D are located at an interval of about 0.1 mm greater than the thickness of the magnetic storage medium away from the magnetic head cores 10A and 10B in the direction away from the magnetic storage medium, respectively. The former test results showed that an output signal read out of the magnetic storage medium has a level of about −20 dB, while the latter test results showed that an output signal read out of the magnetic storage medium has a desired level of about −28 dB. This is because the magnetic head cores 10A and 10B may be viewed as being not located in alignment with the dummy magnetic head cores 10D and 10C, respectively.

Other arrangements are identical with those in the first embodiment, and explanation thereof in detail will be omitted here.

FIG. 10 shows the upper and lower magnetic heads 1b and 1a according to the third embodiment of the invention.

The magnetic head core 10A and the dummy magnetic head core 10C are, like the first embodiment, located out of alignment with the dummy magnetic head core 10D and the magnetic head core 10B in a vertical direction, as viewed in the drawing, but however, outer surfaces of the dummy magnetic head cores 10C and 10D lie flush with the outer surfaces of the sliders 30S.

The dummy magnetic head cores 10C and 10D have the same structure, and the following discussion will refer only to the dummy magnetic head core 10C for the brevity of disclosure.

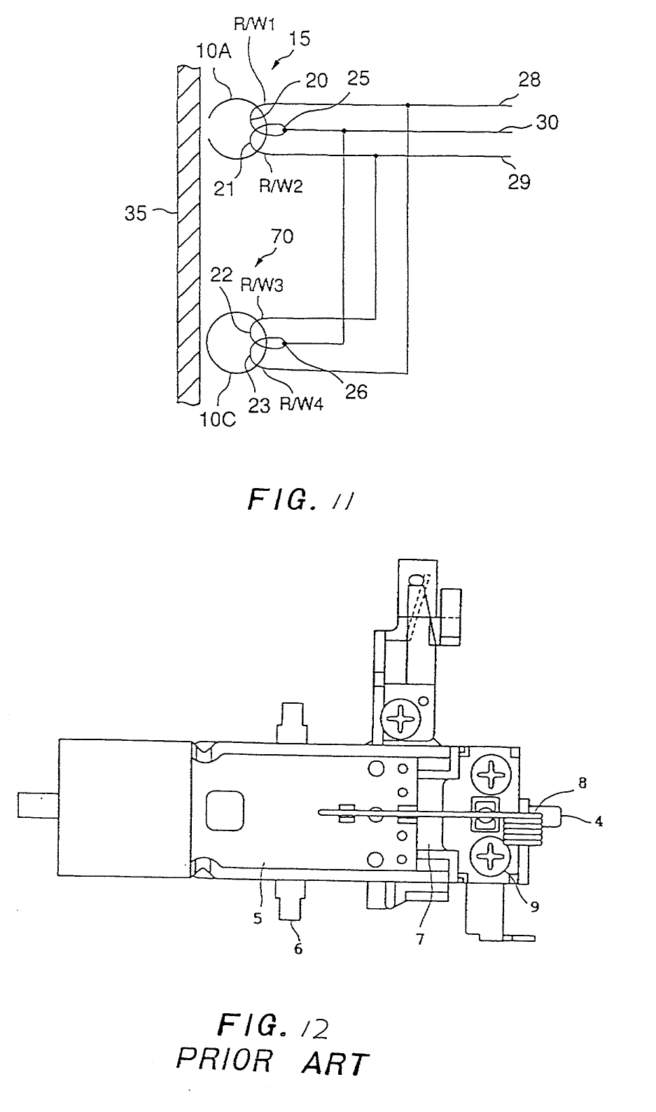

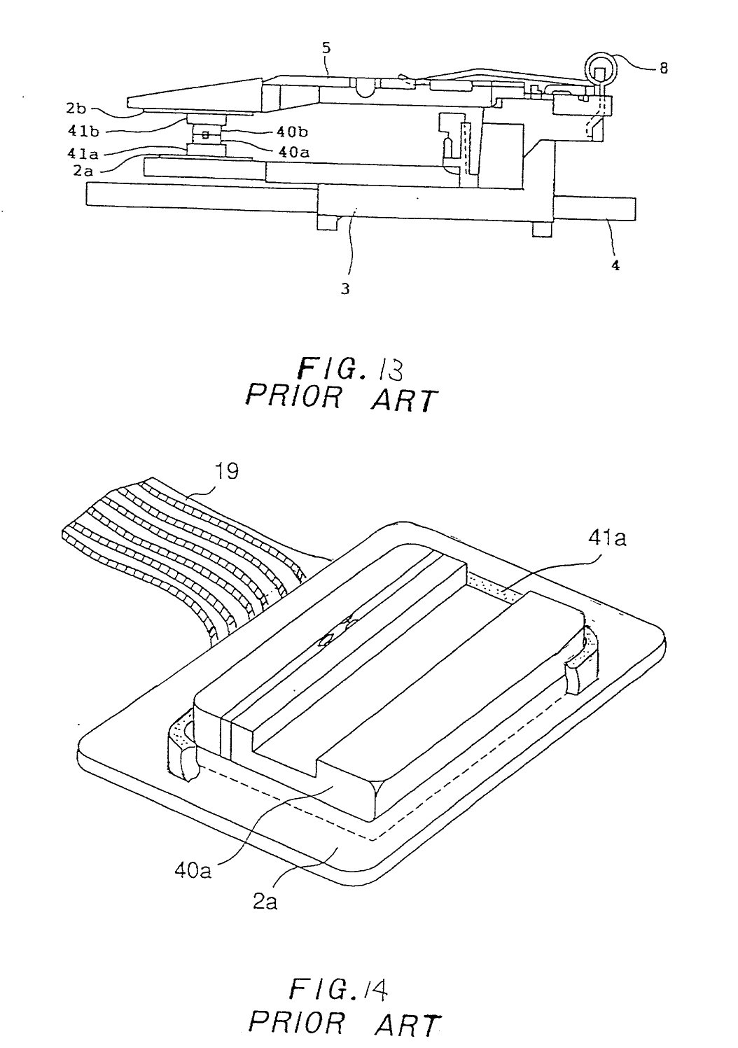

The dummy magnetic head core 10C, as can be seen in FIG. 11, has the coil 70 identical with the coil 15 of the magnetic head core 10A, but with no magnetic gap. Thus, if the dummy magnetic head core 10C is identical in material and shape with the magnetic head core 10A, it will result in a decrease in magnetic resistance. In order to avoid this problem, the dummy magnetic head core 10C of this embodiment is different in material and size (i.e., a sectional area) from the magnetic head core 10A to establish substantially the same magnetic circuit as that of the magnetic head core 10A . As an alternative to this, the number of turns of the coil 70 wound around the dummy magnetic head core 10C may be smaller than that of the coil 15 of the magnetic head core 10A so as to establish substantially the same output characteristics. Therefore, upon input of electric noises, the windings 22 and 23 of the dummy magnetic head core 10C of this embodiment produces outputs which do not contain information data read out of the floppy disk 35 because of no magnetic gap, but with substantially the same bursts as illustrated in FIG. 7 almost simultaneously which are 180° out of phase with those contained in outputs of the windings 20 and 21 of the magnetic head cores 10A, so that outputs from the conductive line 28 and 29 of the flexible cable 19 have no bursts.

Other arrangements are identical with those of the first embodiment, and explanation thereof in detail will be omitted here.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A magnetic head apparatus comprising:
a first magnetic head having a first magnetic head core and a first coil wound around the magnetic head core;
a second magnetic head having a second magnetic head core and a second coil wound around the second magnetic head core, said second magnetic head being opposed to said first magnetic head so as to form a nip in which a magnetic storage medium is held for reading and writing data on and from the magnetic storage medium;
a first dummy magnetic head core around which a first dummy coil is wound to form substantially the same magnetic circuit as that of said first magnetic head, said first dummy magnetic head core being located adjacent said first magnetic head core out of alignment with the second magnetic head core through the magnetic storage medium, the first dummy coil being connected electrically with the first coil of said first magnetic head so that an output of the first dummy coil is added to that of the first coil of said first magnetic head in opposite phase to each other; and
a second magnetic head core around which a second dummy coil is wound to form substantially the same magnetic circuit as that of said second magnetic head, said second dummy magnetic head core being located adjacent said second magnetic head core out of alignment with the first magnetic head core through the magnetic storage medium, the second dummy coil being connected electrically with the second coil of said second magnetic head so that an output of the second dummy coil is added to that of the second coil of said second magnetic head in opposite phase to each other.

2. A magnetic head apparatus as set forth in claim 1, further comprising sliders each of which surrounds one of the first and second magnetic head cores, each of said sliders being made of a non-magnetic insulating material.

3. A magnetic head apparatus as set forth in claim 1, wherein each of the first and second magnetic head cores is made of a polycrystalline ferrite.

4. A magnetic head apparatus as set forth in claim 3, wherein the polycrystalline ferrite is an Mn—Zn ferrite.

5. A magnetic head apparatus as set forth in claim 2, wherein each of the first and second dummy head cores is covered with a corresponding one of the sliders so as not to be opposed outside a surface of the slider.

6. A magnetic head apparatus as set forth in claim 1, wherein the first and second coils and the first and second dummy coils each have a middle tap.

7. A magnetic head apparatus as set forth in claim 1, wherein each of the first and second coils and the first and second dummy coils is made up of windings connected in series.

8. A magnetic head apparatus as set forth in claim 1, wherein each of the first and second dummy magnetic head cores has a magnetic gap located at a distance from the surface of the one of the sliders which is greater than a wavelength of a signal recorded on the magnetic storage medium.

9. A magnetic head apparatus as set forth in claim 1, wherein the nip formed between said first magnetic head and said second magnetic head holds opposed surfaces forming a thickness of the magnetic storage medium, and wherein said first dummy magnetic head core and said second dummy magnetic core are arranged out of alignment with the second magnetic head core and the first magnetic head core in a direction perpendicular to the opposed surfaces of the magnetic storage medium, respectively.

10. A floppy disk drive comprising:
a drive mechanism working to rotate a floppy disk for reading and writing data from and on a floppy disk; and
a magnetic head carriage assembly including: (a) a first magnetic head having a first magnetic head core and a first coil wound around the magnetic head core; (b) a second magnetic head having a second magnetic head core and a second coil wound around the second magnetic head core, said second magnetic head being opposed to said first magnetic head so as to form a nip in which a magnetic storage medium is held for reading and writing data on and from the magnetic storage medium; (c) a first dummy magnetic head core around which a first dummy coil is wound to form substantially the same magnetic circuit as that of said first magnetic head, said first dummy magnetic head core being located adjacent said first magnetic head core out of alignment with the second magnetic head core through the magnetic storage medium, the first dummy coil being connected electrically with the first coil of said first magnetic head so that an output of the first dummy coil is added to that of the first coil of said first magnetic head in opposite phase to each other; and (d) a second magnetic head core around which a second dummy coil is wound to form substantially the same magnetic circuit as that of said second magnetic head, said second dummy magnetic head core being located adjacent said second magnetic head core out of alignment with the first magnetic head core through the magnetic storage medium, the second dummy coil being connected electrically with the second coil of said second magnetic head so that an output of the second dummy coil is added to that of the second coil of said second magnetic head in opposite phase to each other.

11. A floppy disk drive as set forth in claim 10, further comprising sliders each of which surrounds one of the first and second magnetic head cores, each of said sliders being made of a non-magnetic insulating material.

12. A floppy disk drive as set forth in claim 10, wherein each of the first and second magnetic head cores is made of a polycrystalline ferrite.

13. A floppy disk drive as set forth in claim 12, wherein the polycrystalline ferrite is an Mn—Zn ferrite.

14. A floppy disk drive as set forth in claim 11, wherein each of the first and second dummy head cores is covered with a corresponding one of the sliders so as not to be opposed outside a surface of the slider.

15. A floppy disk drive as set forth in claim 14, wherein each of the first and second dummy magnetic head cores has a magnetic gap located at a distance from the surface of the one of the sliders which is greater than a wavelength of a signal recorded on the floppy disk.

16. A floppy disk drive as set forth in claim 10, wherein the first and second coils and the first and second dummy coils each have a middle tap.

17. A floppy disk drive as set forth in claim 10, wherein each of the first and second coils and the first and second dummy coils is made up of windings connected in series.

18. A magnetic head apparatus comprising:
a first magnetic head having a first magnetic head core and a first coil wound around the magnetic head core;
a second magnetic head having a second magnetic head core and a second coil wound around the second magnetic head, said second magnetic head being opposed to said first magnetic head so as to form a nip in which a thickness of a magnetic storage medium are held for reading and writing data on and from the magnetic storage medium;
a first dummy magnetic head core around which a first dummy coil is wound to form substantially the same magnetic circuit as that of said first magnetic head, said first dummy magnetic head core being located at a distance of more than or equal to the thickness of the magnetic storage medium from the first magnetic head core in a direction away from the magnetic storage medium and in a thicknesswise direction of the magnetic storage medium, the first dummy coil being connected electrically with the first coil of said first magnetic head so that an output of the first dummy coil is added to that of the first coil of said first magnetic head in opposite phase to each other; and
a second dummy magnetic head core around which a second dummy coil is wound to form substantially the same magnetic circuit as that of said second magnetic head, said second dummy magnetic head core being located at a distance of more than or equal to the thickness of the magnetic storage medium from the second magnetic head core in a direction away from the magnetic storage medium and in a thicknesswise direction of the magnetic storage medium, the second dummy coil being connected electrically with the second coil of said second magnetic head so that an output of the second dummy coil is added to that of the second coil of said second magnetic head in opposite phase to each other.

19. A magnetic head apparatus as set forth in claim 18, further comprising sliders each of which surrounds one of the first and second magnetic head cores, each of said sliders being made of a non-magnetic insulating material.

20. A magnetic head apparatus as set forth in claim 18, wherein each of the first and second magnetic head cores is made of a polycrystalline ferrite.

21. A magnetic head apparatus as set forth in claim 20, wherein the polycrystalline ferrite is an Mn—Zn ferrite.

22. A magnetic head apparatus as set forth in claim 19, wherein each of the first and second dummy head cores is covered with a corresponding one of the sliders so as not to be opposed outside a surface of the slider.

23. A magnetic head apparatus as set forth in claim 18, wherein the first and second coils and the first and second dummy coils each have a middle tap.

24. A magnetic head apparatus as set forth in claim 18, wherein each of the first and second coils and the first and second dummy coils is made up of windings connected in series.

25. A magnetic head apparatus as set forth in claim 18, wherein each of the first and second dummy magnetic head cores has a magnetic gap located at a distance from the surface of the one of the sliders which is greater than a wavelength of a signal recorded on the floppy disk.

26. A floppy disk drive comprising:
a drive mechanism working to rotate a floppy disk for reading and writing data from and on a floppy disk; and
a magnetic head carriage assembly including: (a) a first magnetic head having a first magnetic head core and a first coil wound around the magnetic head core; (b) a second magnetic head having a second magnetic head core and a second coil wound around the second magnetic head, said second magnetic head being opposed to said first magnetic head so as to form a nip in which a thickness of a magnetic storage medium is held for reading and writing data on and from the magnetic storage medium; (c) a first dummy magnetic head core around which a first dummy coil is wound to form substantially the same magnetic circuit as that of said first magnetic head, said first dummy magnetic head core being located at a distance of more than or equal to the thickness of the magnetic storage medium from the first magnetic head core in a direction away from the magnetic storage medium and in a thicknesswise direction of the magnetic storage medium, the first dummy coil being connected electrically with the first coil of said first magnetic head so that an output of the first dummy coil is added to that of the first coil of said first magnetic head in opposite phase to each other; and (d) a second dummy magnetic head core around which a second dummy coil is wound to form substantially the same magnetic circuit as that of said second magnetic head, said second dummy magnetic head core being located at a distance of more than or equal to the thickness of the magnetic storage medium from the second magnetic head core in a direction away from the magnetic storage medium and in a thicknesswise direction of the magnetic storage medium, the second dummy coil being connected electrically with the second coil of said second magnetic head so that an output of the second dummy coil is added to that of the second coil of said second magnetic head in opposite phase to each other.

27. A floppy disk drive as set forth in claim 26, further comprising sliders each of which surrounds one of the first and second magnetic head cores, each of said sliders being made of a non-magnetic insulating material.

28. A floppy disk drive as set forth in claim 26, wherein each of the first and second magnetic head cores is made of a polycrystalline ferrite.

29. A floppy disk drive as set forth in claim 28, wherein the polycrystalline ferrite is an Mn—Zn ferrite.

30. A floppy disk drive as set forth in claim 28, wherein each of the first and second dummy head cores is covered with a corresponding one of the sliders so as not to be opposed outside a surface of the slider.

31. A floppy disk drive as set forth in claim 30, wherein each of the first and second dummy magnetic head core has a magnetic gap located at a distance from the surface of the one of the sliders which is greater than a wavelength of a signal recorded on the floppy disk.

32. A floppy disk drive as set forth in claim 26, wherein the first and second coils and the first and second dummy coils each have a middle tap.

33. A floppy disk drive as set forth in claim 26, wherein each of the first and second coils and the first and second dummy coils is made up of windings connected in series.

34. A magnetic head apparatus comprising:
a first magnetic head having a first magnetic head core and a first coil wound around the magnetic head core;
a second magnetic head having a second magnetic head core and a second coil wound around the second magnetic head core, said second magnetic head being opposed to said first magnetic head so as to form a nip in which a magnetic storage medium is held for reading and writing data on and from the magnetic storage medium;
a first dummy magnetic head core around which a first dummy coil is wound to form substantially the same magnetic circuit as that of said first magnetic head, said first dummy magnetic head core having no magnetic gap used to read and write data on and from the magnetic storage medium and being located adjacent said first magnetic head core out of alignment with the second magnetic head core through the magnetic storage medium, the first dummy coil being connected electrically with the first coil of said first magnetic head so that an output of the first dummy coil is added to that of the first coil of said first magnetic head in opposite phase to each other; and
a second magnetic head core around which a second dummy coil is wound to form substantially the same magnetic circuit as that of said second magnetic head, said second dummy magnetic head core having no magnetic gap used to read and write data on and from the magnetic storage medium and being located adjacent said second magnetic head core out of alignment with the first magnetic head core through the magnetic storage medium, the second dummy coil being connected electrically with the second coil of said second magnetic head so that an output of the second dummy coil is added to that of the second coil of said second magnetic head in opposite phase to each other.

35. A magnetic head apparatus as set forth in claim 34, further comprising sliders each of which surrounds one of the first and second magnetic head cores, each of said sliders being made of a non-magnetic insulating material.

36. A magnetic head apparatus as set forth in claim 34, wherein each of the first and second magnetic head cores is made of a polycrystalline ferrite.

37. A magnetic head apparatus as set forth in claim 36, wherein the polycrystalline ferrite is an Mn—Zn ferrite.

38. A magnetic head apparatus as set forth in claim 35, wherein an outer surface of each of the first and second dummy head cores lies flush with an outer surface of a corresponding one of said sliders.

39. A magnetic head apparatus as set forth in claim 34, wherein the first and second coils and the first and second dummy coils each have a middle tap.

40. A magnetic head apparatus as set forth in claim 34, wherein each of the first and second coils and the first and second dummy coils is made up of windings connected in series.

41. A magnetic head apparatus as set forth in claim 34, wherein the nip formed between said first magnetic head and said second magnetic head holds a thickness of the magnetic storage medium, and wherein said first dummy magnetic head core and said second dummy magnetic core are arranged out of alignment with the second magnetic head core and the first magnetic head core in a thicknesswise direction of the magnetic storage medium, respectively.

42. A floppy disk drive comprising:
a drive mechanism working to rotate a floppy disk for reading and writing data from and on a floppy disk; and
a magnetic head carriage assembly including: (a) a first magnetic head having a first magnetic head core and a first coil wound around the magnetic head core; (b) a second magnetic head having a second magnetic head core and a second coil wound around the second magnetic head core, said second magnetic head being opposed to said first magnetic head so as to form a nip in which a magnetic storage medium is held for reading and writing data on and from the magnetic storage medium; (c) a first dummy magnetic head core around which a first dummy coil is wound to form substantially the same magnetic circuit as that of said first magnetic head, said first dummy magnetic head core having no magnetic gap used to read and write data on and from the magnetic storage medium and being located adjacent said first magnetic head core out of alignment with the second magnetic head core through the magnetic storage medium, the first dummy coil being connected electrically with the first coil of said first magnetic head so that an output of the first dummy coil is added to that of the first coil of said first magnetic head in opposite phase to each other; and (d) a second magnetic head core around which a second dummy coil is wound to form substantially the same magnetic circuit as that of said second magnetic head, said second dummy magnetic head core having no magnetic gap used to read and write data on and from the magnetic storage medium and being located adjacent said second magnetic head core out of alignment with the first magnetic head core through the magnetic storage medium, the second dummy coil being connected electrically with the second coil of said second magnetic head so that an output of the second dummy coil is added to that of the second coil of said second magnetic head in opposite phase to each other.

43. A floppy disk drive as set forth in claim 42, further comprising sliders each of which surrounds one of the first and second magnetic head cores, each of said sliders being made of a non-magnetic insulating material.

44. A floppy disk drive as set forth in claim 42, wherein each of the first and second magnetic head cores is made of a polycrystalline ferrite.

45. A floppy disk drive as set forth in claim 44, wherein the polycrystalline ferrite is an Mn—Zn ferrite.

46. A floppy disk drive as set forth in claim 42, wherein an outer surface of each of the first and second dummy head cores lies flush with an outer surface of a corresponding one of said sliders.

47. A floppy disk drive as set forth in claim 42, wherein the first and second coils and the first and second dummy coils each have a middle tap.

48. A floppy disk drive as set forth in claim 42, wherein each of the first and second coils and the first and second dummy coils is made up of windings connected in series.

49. A floppy disk drive as set forth in claim 42, wherein the nip formed between said first magnetic head and said second magnetic head holds a thickness of the magnetic storage medium, and wherein said first dummy magnetic head core and said second dummy magnetic core are arranged out of alignment with the second magnetic head core and the first magnetic head core in a thicknesswise direction of the magnetic storage medium, respectively.
